(19) United States
(12) Patent Application Publication
(10) Pub. No.: US 2013/0042414 A1
(43) Pub. Date: Feb. 21, 2013

(54) AIR INLET FOR PATIENT SUPPORT DEVICE

(71) Applicants: Austin Schreiber, Kalamazoo, MI (US); Kevin M. Patmore, Plainwell, MI (US)

(72) Inventors: Austin Schreiber, Kalamazoo, MI (US); Kevin M. Patmore, Plainwell, MI (US)

(73) Assignee: STRYKER CORPORATION, Kalamazoo, MI (US)

(21) Appl. No.: 13/571,817

(22) Filed: Aug. 10, 2012

Related U.S. Application Data
(60) Provisional application No. 61/524,543, filed on Aug. 17, 2011.

(51) Int. Cl. A47C 27/08; F16L 25/00; F16L 31/00

(52) U.S. Cl. 5/714; 5/706; 285/223; 285/9.1

(57) ABSTRACT

A method and apparatus for coupling and decoupling an air supply hose to an inflatable device. The inflatable device may be adapted to support a patient, such as an air mattress or an inflatable patient transfer mat that rides on an air cushion. The method and apparatus utilize an air inlet that normally assumes a flat orientation. The air inlet includes resilient members that allow the air inlet to flex out of the flat orientation in response to a compressive force. The compressive force changes the air inlet's orientation into a generally round orientation that is sized to accept an air supply hose. A collar on the air supply hose is able to frictionally engage an edge in the air inlet in order to prevent undesired removal of the hose from the inlet. Magnets may be used to help return the inlet to the flat orientation when not in use.

This application claims priority to U.S. provisional application Ser. No. 61/524,543 filed Aug. 17, 2011, by applicants Austin Schreiber et al., and entitled AIR INLET FOR PATIENT SUPPORT DEVICE, the complete disclosure of which is hereby incorporated herein by reference.

### BACKGROUND OF THE INVENTION

The present invention relates to patient support devices, and more particularly to a system and method for coupling an air supply hose to an air inlet of an inflatable patient support device.

Patient support devices often include an inflatable structure, such as an air mattress or the like, that is adapted to provide a cushioned support for supporting a patient. Such supports may be found on beds, stretchers, cots, and other support devices found in hospitals, nursing homes, and other places for patient care. Such inflatable supports may also be used as part of a patient transfer device in which the inflatable cushion includes a plurality of air passageways on its bottom surface that, when coupled to a source of pressurized air, create an air cushion underneath the transfer device. The air cushion reduces the frictional resistance between the inflatable cushion and the underlying surface, thereby allowing the patient and cushion to slide more easily. Such improved sliding allows a patient to be more easily transferred from one surface to another.

### SUMMARY OF THE INVENTION

The present invention relates to systems and methods for coupling and decoupling a hose from a source of fluid, such as air, to an inlet into the inflatable patient device. The systems and methods facilitate the easy coupling and decoupling of the hose to the inlet. Further, the various embodiments of the systems and methods enable the air inlet to be stowed in a compact position, to be more easily used and/or cleaned, to be less susceptible to contamination, and to expedite the coupling and decoupling of the air supply hose to the air inlet.

According to one aspect of the invention, an inflatable patient support device is provided. The support includes a flexible body and an air inlet coupled thereto. The flexible body is adapted to be inflated and deflated and to support a patient on a top surface thereof. The air inlet includes a plurality of resilient members positioned near an opening defined in the air inlet. The resilient members bias the opening toward a first position in which the inlet assumes a flat orientation. The resilient members also flex away from each other toward a second, non-flat position when a compressive force is applied to the inlet substantially parallel to a longitudinal extent of the resilient members.

According to another embodiment, an air inlet for an inflatable patient transfer device is provided. The inflatable patient transfer device includes a flexible body adapted to be inflated and deflated, wherein the body includes an underside and a top side and the underside has a plurality of air passages adapted to allow air from inside the body to escape to generate an air cushion underneath the flexible body. The top side is adapted to support a patient thereon. The air inlet includes first and second substantially planar surfaces that are positioned opposite from each other and which each have first and second sides. The first and second sides of the first surface are coupled to the first and second sides of the second planar surface. The first and second surfaces are adapted to flex between a first position in which the first and second surfaces are substantially flat and parallel to each other and a second position in which the first and second surfaces form a curved shape sized to accept an air supply hose between the first and second surfaces.

According to still another embodiment, a method is provided for using an air inlet of an inflatable patient support device and an air supply hose. The method includes applying a compressive force to opposite sides of the air inlet until the air inlet flexes from a substantially flat shape into a curved shape having an opening sized to receive the air supply hose. The method further includes inserting the air supply hose into the opening until a collar defined on the air supply hose moves past an edge defined in an interior of the inlet, and terminating the compressive force in order to allow the edge to engage a portion of the collar to thereby resist removal of the air supply hose from the air inlet.

According to still other embodiments, the resilient members may be leaf springs, and the leaf springs may be made from a thermoset urethane. The air inlet may include a first tubular section adjacent the opening and a second tubular section adjacent the first tubular section wherein the second tubular section has an inside diameter less than an inside diameter of the first tubular section. A plurality of magnets may be positioned adjacent the opening and the magnets may be arranged such that a magnetic force urges the resilient members toward the first, closed position. The magnets may be positioned together with the resilient members as laminates. The air inlet may further include a plastic, releasable seal that includes a first and second half, wherein the first and second half are adapted to releasably engage each other in an airtight manner. The resilient members may further includes an interior surface defining an edge that engages a collar on the air hose when the air hose is inserted into the inlet, wherein the edge prevents withdrawal of the hose out of the inlet when the compressive forces are relaxed or terminated.

### BRIEF DESCRIPTION OF THE DRAWINGS

FIG. 1 is a perspective view of an air inlet according to one embodiment shown in a flat orientation;

FIG. 2 is a plan view of the air inlet of FIG. 1;

FIG. 3 is a sectional view of the air inlet of FIG. 2 taken along the line III-III;

FIG. 4 is a perspective view of an air supply hose and the air inlet wherein the air inlet has been squeezed into a non-flat orientation;

FIG. 5 is a perspective view of the air supply hose and air inlet coupled together;

FIG. 6 is a longitudinal sectional view of the air supply hose and air inlet when coupled together;

FIG. 7 is a perspective view of an air inlet according to an alternative embodiment;

FIG. 8 is a perspective view of an illustrative inflatable patient transfer device into which any of the air inlet embodiments may be incorporated;

FIG. 9 is a perspective view of a pair of patient support devices illustrating how the patient support device of FIG. 8 may be used to transfer a patient from one of the patient support devices to the other; and

FIG. 10 is a sectional view of patient support device with a pair of air inlets, one of which is coupled to an air hose and the other of which is not.

### DETAILED DESCRIPTION OF THE EMBODIMENTS

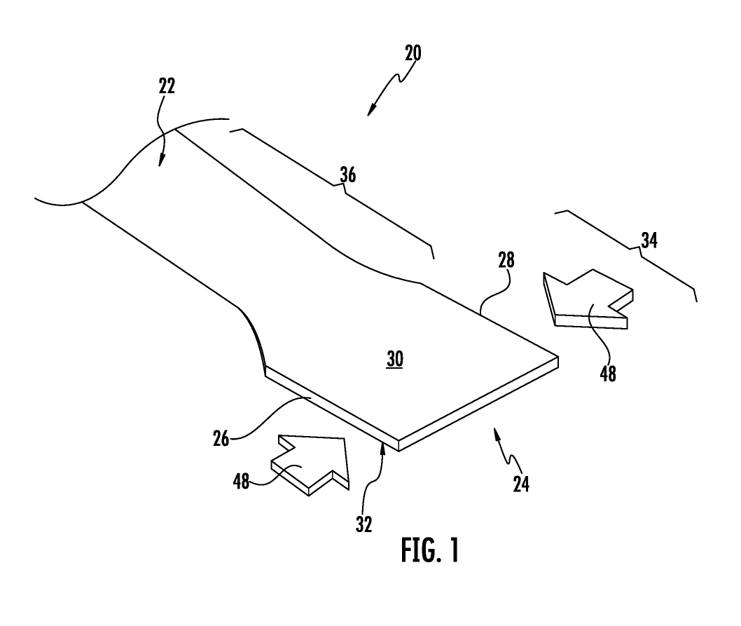

An air inlet 20 according to one embodiment of the invention is depicted in FIG. 1. While not illustrated in FIG. 1, air inlet 20 is adapted to be incorporated into an inflatable patient support device, such as, but not limited to an air mattress, a patient transfer device that travels on an air cushion, or any other type of patient support device that utilizes pressurized air for providing support to one or more portions of a patient's body. Air inlet 20 includes a proximal end 22 and a distal end 24. Proximal end 22 attaches to the air mattress or other patient support device and may extend partially into the interior of the patient support device, as will be discussed more below. Distal end 24 is adapted to receive an air supply hose, as will also be discussed in greater detail below. Air inlet 20 further includes a first side 26, a second side 28, a top surface 30, and a bottom surface 32. In the illustrated embodiment, air inlet 20 also includes a larger tubular section 34 and a smaller tubular section 36. Smaller tubular section 36 is positioned adjacent proximal end 22, while larger tubular section 34 is positioned adjacent distal end 24.

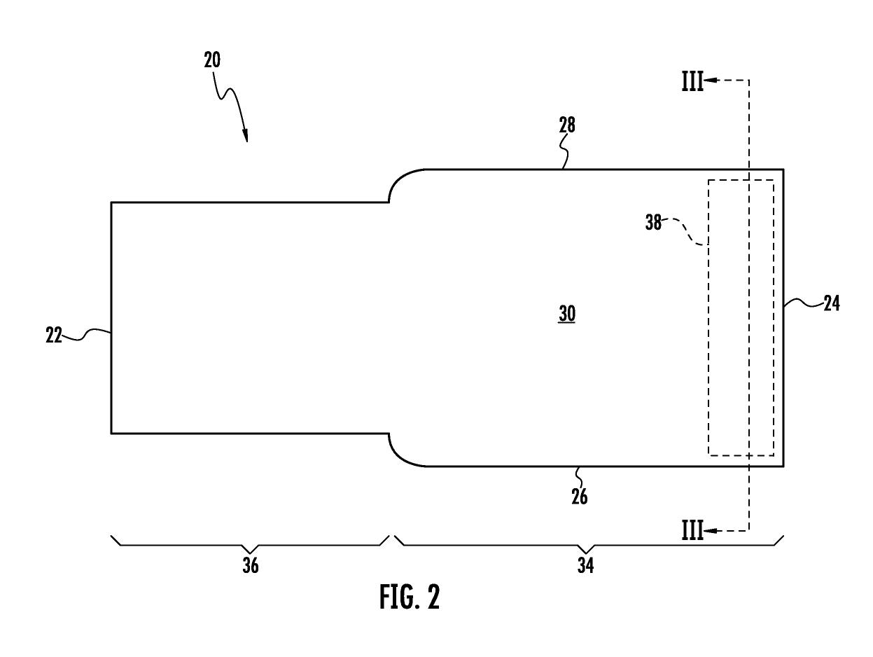

FIG. 2 is a plan view of air inlet 20. As shown therein, air inlet 20 includes a plurality of resilient members 38 positioned adjacent distal end 24 and inside of air inlet 20. As indicated by the dashed lines of FIG. 2, resilient members 38 are not visible externally of air inlet 20, but instead are enclosed in the material of air inlet 20, as will be discussed in greater detail below.

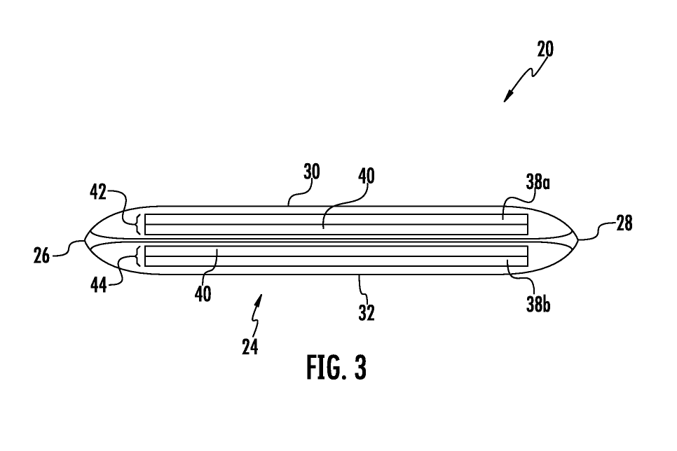

The position, orientation, and size of resilient members 38 can be seen in more detail in FIG. 3, which is a cross-section taken along the lines III-III of FIG. 2. In the embodiment illustrated in FIG. 3, there are two resilient members 38a and 38b. Resilient members 38 have a longitudinal dimension that extends substantially from first side 26 to second side 28 of air inlet 20. Resilient members 38 may be leaf-springs, or other types of structures that are flexible enough to bend into a curved shape sized to accept an air supply hose and thereafter substantially return to the generally flat orientation depicted in FIG. 3. The material of resilient members 38 may vary widely. In some embodiments, resilient members 38 may be made from steel, beryllium, copper, plastic, or other materials. In at least one embodiment, resilient members 38 are made from a thermoset urethane.

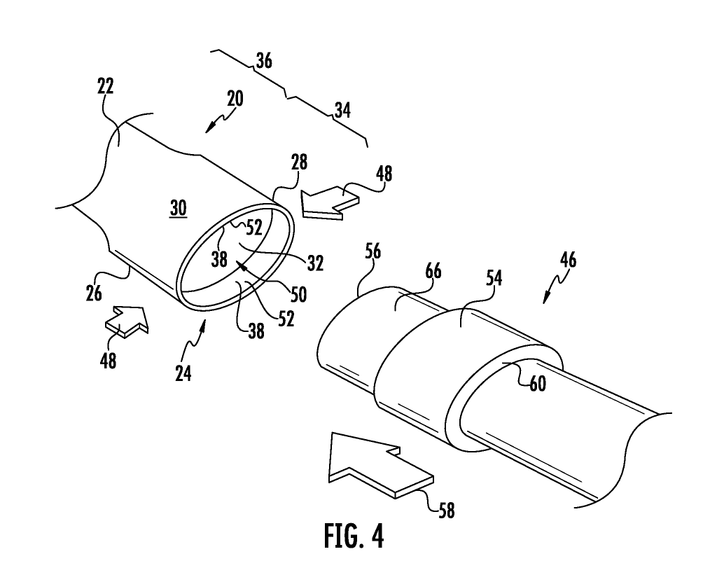

Resilient members 38, in the illustrated embodiment, have a perimeter defined by a generally rectangular shape and have a thin, generally planar body. The generally planar body of the resilient members 38 is parallel to the generally planar top and bottom surfaces 30 and 32 of air inlet 20. It will be understood by those skilled in the art that the shape, size, and construction of resilient members 38 can vary from that illustrated in the accompanying drawings. It will also be understood by those skilled in the art that the placement and number of resilient member 38 can vary from what is shown in the attached drawings. For example, instead of a pair of resilient members 38, it would be possible to modify air inlet 20 such that resilient members 38a and 38b were connected together to thereby form a single resilient member 38 having a ring-like shape that was flexible between the flat orientation of FIGS. 1 and 3 and the open orientation of FIG. 4. Alternatively, more than two resilient members 38 could be positioned inside of air inlet 20.

FIG. 3 also illustrates a pair of magnets 40. Each magnet 40 is laminated together with an adjacent resilient member 38. Magnets 40 are oriented such that a magnetic force of attraction exists between the magnet 40 positioned along top surface 30 and the magnet 40 positioned along bottom surface 32. Thus magnets 40 are positioned such that the attractive magnetic force between magnets 40 tends to close off distal end 24 and maintain air inlet 20 in the flat orientation depicted in FIGS. 1 and 3. The magnetic polar arrangement of magnets 40 may take on any suitable orientation that achieves the attractive force that biases air inlet 20 toward the flat orientation. A greater or lesser number of magnets 40 may alternatively be used.

In the embodiment illustrated in FIG. 3, magnets 40 are elongated strips generally sized similar to the size of resilient members 38. Each magnet 40 of FIG. 3 is laminated together with a corresponding resilient member 38. Thus, one magnet 40 and one resilient member 38 together form a first upper laminate 42, and another resilient member 38 and magnet 40 together form a second lower laminate 44. The means by which magnet 40 and resilient members 38 are laminated together may take on any suitable known means for lamination. Such means may include radio frequency welding, adhesives, other types of welding, or any other suitable methods for securing magnets 40 and resilient members 38 into laminate pairs. In other alternative embodiments, magnets 40 and resilient members 38 may be positioned in configurations wherein a space exists between each of the magnets 40 and each of the resilient members 38. For example, magnets 40 may be positioned in a location that is off set from resilient members 38. Such off setting may be in the direction parallel to a line connecting proximal end 22 to distal end 24. Alternatively, magnets 40 may be off set from resilient members 38 in other manners.

It will also be understood by those skilled in the art that the size and shape of magnets 40 may vary substantially from that shown in the accompanying drawings. For example, magnets 40, as illustrated, are substantially the same shape and size as resilient members 38. This may be altered. Thus, magnets 40 could be made smaller than resilient members 38, or they could be made larger. Magnets 40 could also have shapes that are different than those of resilient members 38. Magnets 40 could therefore be circular, curved, or otherwise non-rectangular. Still other variations are possible. Magnets 40 could also be entirely eliminated in at least some embodiments of air inlet 20.

The purpose of magnets 40, when present, is to help return air inlet 20 to the closed position illustrated in FIGS. 1 and 3. While resilient members 38 also urge air inlet 20 to the closed position, resilient members 38 may, over time, become set in a shape that is not perfectly flat. Thus, resilient members 38 may, over time, take on a permanent bend that fails to urge surfaces 30 and 32 completely back to the flat orientation when compressive forces are no longer applied to sides 26 and 28. Magnets 40 help ensure that when air inlet 20 is not in use, top and bottom surfaces 30 and 32 completely return to the closed position, thereby returning air inlet 20 to a substantially flat orientation.

It will of course be understood by those skilled in the art that magnets 40 are an optional component of air inlet 20. That is, air inlet 20 can be practiced, in some embodiments, without the use of any magnets 40, or any equivalent structures. Air inlet 20 could, therefore, be manufactured with just resilient members 38 and no magnets 40. As another alternative, structures other than magnets 40 could be used to help ensure that resilient members 38 return completely to the flat orientation. Such other structures may include a Velcro seal, a zipper, one or more snaps, a releasable plastic seal of the type commonly found on conventional plastic sandwich bags, or other structures serving similar functions.

FIG. 4 illustrates air inlet 20 in an open position wherein air inlet 20 is able to receive an air supply hose 46. Air inlet 20 is moved from the closed position of FIGS. 1 and 3 to the open position of FIG. 4 by applying a compressive force to first and second sides 26 and 28. The direction of the compressive force is illustrated in FIG. 4 by arrows 48. The compressive force is applied to first and second sides 26 and 28 of air inlet 20 generally near the ends of resilient members 38. The compressive force causes the resilient members 38 to flex out of their generally flat orientation into curved orientations. More specifically, resilient member 38a flexes into a curved shaped that extends away from the curved shape of resilient member 38b. This creates an opening 50 at distal end 24. Opening 50 is sized sufficiently large enough to receive air supply hose 46. A center 52 of resilient member 38a will increase its vertical separation from center 52 of resilient member 38b when compressive force is applied in the direction of arrows 48. Therefore, a user of air inlet 20 need only squeeze first and second sides 26 and 28 with a force sufficient to space apart centers 52 such that sufficient vertical separation exists to accept air supply hose 46. Air inlet 20 is manufactured sufficiently large such that the horizontal spacing between first and second sides 26 and 28 can accept air supply hose 46, even after the compressive force has moved sides 26 and 28 toward each other to create vertical space between surfaces 30 and 32.

Air supply hose 46 in the illustrated embodiment includes a collar 54 that extends around the circular periphery of hose 46. Collar 54 is positioned generally a short distance away from an end 56 of hose 47. As will be explained in further detail below, collar 54 is used to help secure hose 46 to air inlet 20 after air inlet 20 and hose 46 are coupled together.

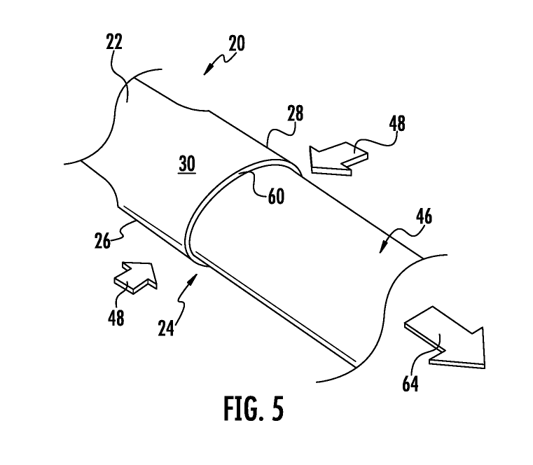

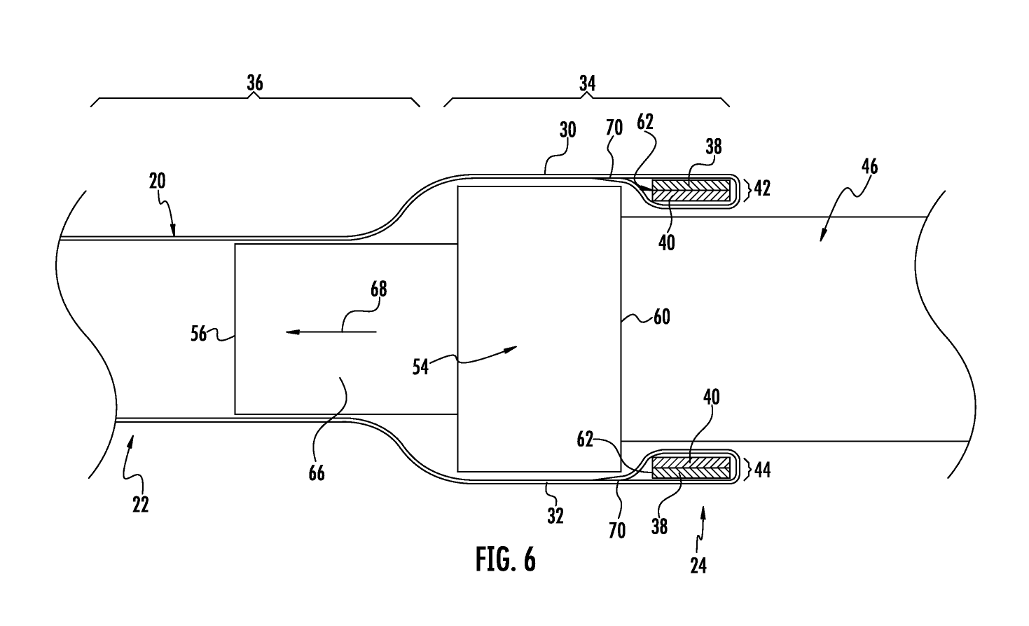

In order to couple air inlet 20 to air supply hose 46, a user applies a compressive force to first and second sides 26 and 28 in the direction indicated by arrows 48 (FIG. 4). This compressive force is applied at a sufficient level to cause a vertical separation between centers 52 of resilient members 38 that is large enough to accept hose 46. Thereafter, hose 46 is inserted into opening 50 in the direction indicated by arrow 58. FIG. 5 provides an illustration of air supply hose 46 after it has been inserted into opening 50 of air inlet 20 and coupled thereto. As can also be seen in FIG. 5, hose 46 has been inserted into air inlet 20 sufficiently far such that collar 54 is positioned completely inside of larger tubular section 34 of inlet 20. Once supply hose 46 has been sufficiently inserted into air inlet 20, the user releases the first and second sides 26 and 28 and no longer needs to apply a compressive force. With the termination of the compressive force, the natural tendency of resilient members 38 to return toward their flat orientation will cause resilient members 38 to grip hose 46. Further, as can be more easily seen with respect to FIG. 6, and as will be discussed more below, the interaction of resilient members 38 with collar 54 prevents hose 46 from being removed from air inlet 20 in the absence of sufficient compressive forces being applied to sides 26 and 28 in the direction of arrows 48.

FIG. 6 illustrates a cross section of air inlet 20 and air supply hose 46 when the two are coupled together. As can be seen, collar 54 includes a rear surface 60 that is generally perpendicular to the longitudinal extent of hose 46. Further, upper and lower laminates 42 and 44 both include an inner edge 62 that is oriented generally parallel to rear surface 60 of collar 54. In the absence of compressive forces being applied to first and second sides 26 and 28, inner edges 62 will abut against rear surface 60 of collar 54 when hose 46 is pulled in the direction of arrow 64 of FIG. 5. Stated alternatively, the frictional interference of inner edge 62 with rear surface 60 of collar 54 prevents hose 46 from being withdrawn out of air inlet 20 in the absence of sufficient compressive forces being applied to first and second sides 26 and 28. Therefore, if a user stops supplying compressive forces to first and second sides 26 and 28 after hose 46 has been inserted into air inlet 20, hose 46 is prevented from being withdrawn.

As can more clearly be seen in FIG. 6, air supply hose 46 includes a nozzle portion 66 positioned between end 56 of hose 46 and collar 54. When hose 46 is inserted into inlet 20, nozzle portion 66 gets at least partially inside smaller tubular section 36. The outer diameter of nozzle portion 66 is substantially similar to the inner diameter of smaller tubular section 36. There is, therefore, relatively little play between the material of inlet 20 in smaller tubular section 36 and nozzle portion 66. While the contact between nozzle portion 66 and smaller tubular section 36 does not need to form an air tight seal, it may be desirable to avoid substantially large gaps between nozzle portion 66 and the material of inlet 20 in smaller tubular section 36. Nozzle portion 66 may be, in several embodiments, tapered in order to fit into smaller section 36. In other embodiments, nozzle portion 66 need not be tapered.

When air is pumped through air supply hose 46 into inlet 20 in the direction indicated by arrow 68 of FIG. 6, the fluid dynamics of the moving air tend to draw the material of smaller tubular section 36 tightly against nozzle portion 66. Relatively little, if any, air pumped by supply hose 46 escapes out of opening 50 of air inlet 20. Instead, substantially all of the air supplied by hose 46 will flow into air inlet 20 and the attached air mattress, or other inflatable device coupled to air inlet 20.

FIG. 6 illustrates one manner in which resilient members 38 and magnets 40 may be secured to inlet 20. As shown in FIG. 6, the material of inlet 20 is folded over adjacent opening 50 and secured to itself at a seam 70. In the example of FIG. 6, seam 70 is on the interior of air inlet 20. Seam 70 could, alternatively, be on the exterior of air inlet 20. Still further, seam 70 could be positioned in other locations. In still other embodiments, resilient members 38 and/or magnets 40 may be attached to air inlet 20 in other fashions that would not involve the seams.

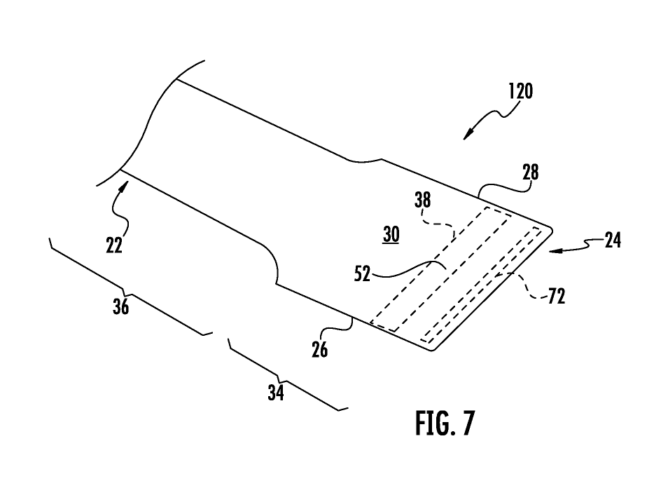

FIG. 7 illustrates an alternative air inlet 120. Air inlet 120 differs from inlet 20 in that air inlet 120 includes a releasable seal 72 positioned between distal end 24 and resilient members 38. The remaining construction of inlet 120 is the same as air inlet 20, and like numbered elements are used to identify these common components. Releasable seal 72 may be an air tight seal that can be opened and closed during use and non-use, respectively. Releasable seal 72 may be a plastic rib and groove type seal commonly found in conventional sandwich bags, kitchen bags, and the like. One example of such a releasable seal includes the releasable seal found on plastic bags sold under the Zip-Loc trademark. Other types of releasable seals may also be used. Such releasable seals may include a first half attached to the underside of top surface 30 and a second half attached to the top side of bottom surface 32 wherein the two halves are releasably sealable together. After air inlet 20 is done being used, releasable seal 72 may be sealed in order to prevent air from entering into opening 50. This helps prevent any infectious materials or contaminants from potentially entering the interior of air inlet 20. When it is time to use air inlet 20, releasable seal 72 is pulled apart, thereby providing access to opening 50.

In other embodiments, releasable seal 72 may be constructed out of different materials besides plastic ribs and grooves. Still further, in some embodiments, releasable seal 72 need not be constructed to provide an air-tight seal when closed. Thus, releasable seal 72 could, in some embodiments, be made from Velcro, a zipper, one or more snaps, or the like.

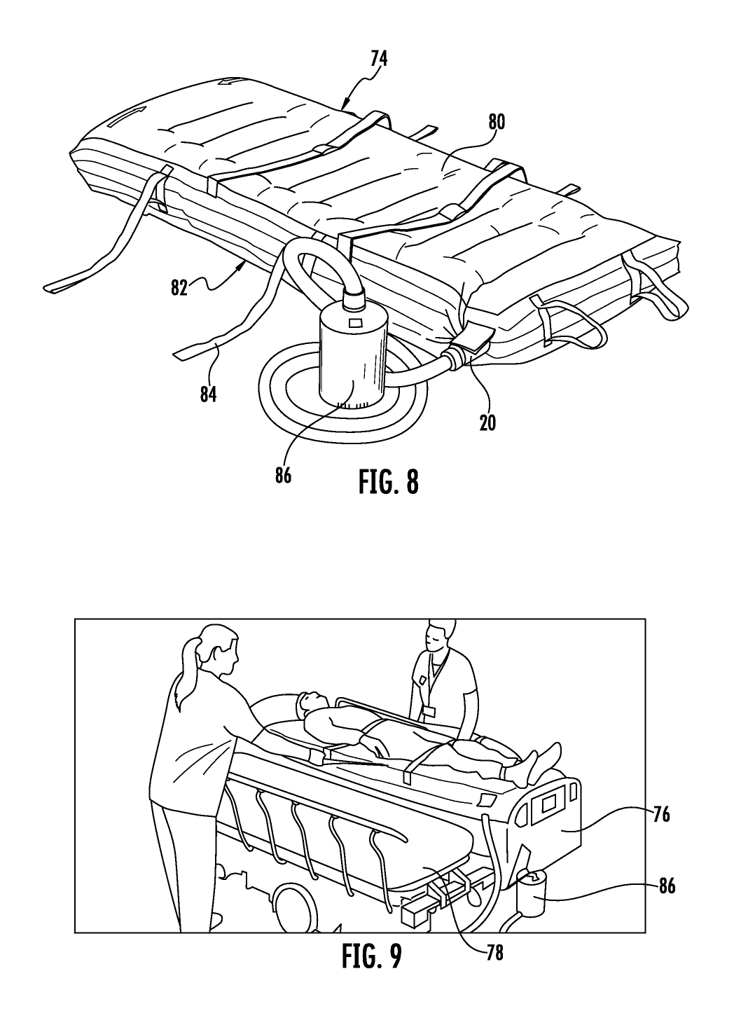

FIG. 8 illustrates one embodiment of a patient support 74 to which any of the various embodiments of air inlets 20 and 120 may be coupled. Patient support 74 of FIG. 8 is a transfer device that assists in transferring a patient laterally from one surface to another surface. For example, as illustrated in FIG. 9, patient support 74 may be used to transfer a patient from a first bed 76 to a second bed 78. Patient support 74 assists in the lateral transfer of the patient from a first surface to a second surface by creating an air cushion on the underside of patient support 74. This air cushion reduces the frictional resistance that otherwise resists horizontal sliding of support 74. Further details regarding the construction and operation of one example of such a patient transfer device can be found in U.S. patent application Ser. No. 11/801,007 filed May 8, 2007 by Richard DeLuca et al. and entitled Air Bearing Pallet, the complete disclosure of which is hereby incorporated herein by reference. Additional details regarding the construction and operation of another embodiment of patient support device 74 may be found in U.S. patent application Ser. No. 12/554,431 filed Sep. 4, 2009 by Schreiber et al, entitled Patient Transfer Device, the complete disclosure of which is also hereby incorporated herein by reference in its entirety.

Patient support 74 includes a top surface 80 and a bottom surface 82. Top surface 80 is adapted to support a patient thereon. If support 74 is constructed to assist in patient transfer through the use of an air cushion, bottom surface 82 will include a plurality of perforations or holes (not shown) out of which pressurized air may escape when patient support 74 is inflated. This escaping air creates an air cushion on the underside of patient support 74, thereby reducing frictional resistance to lateral motion. Patient support 74 may also include a plurality of straps 84 for securing a patient thereto.

In order to use patient support 74, it must first be inflated. As illustrated in FIG. 8, a air source 86, which may be a pump, a blower, or the like, is connected to air inlet 20 or 120 of patient support 74. Air supply hose 46 of air source 86 inserts into air inlet 20 or 120 in the manner previously described. Once inserted, air flows from source 86 into the interior of patient support 74, thereby inflating the support. If used to transfer a patient on an air cushion, air will continue to flow into patient support 74 while the patient is transferred from one surface to another. After the patient transfer is complete, the pressurized air, source 86 may be turned off and air hose 46 removed from air inlet 20 or 120. This removal is accomplished in the manner discussed above. That is, a user squeezes first and second sides 26 and 28 of inlet 20, thereby expanding opening 50 a sufficient amount to allow hose 46 to be retracted out of opening 50.

Air inlet 20 can also be used on patient supports that are not adapted to transfer patients from one surface to another. As one example, air inlet 20 can be used on inflatable mattresses which are not adapted to provide an air cushion for facilitating the sliding movement of the support. Air inlet 20 and 120 may also be used as an inlet into other inflatable devices, other than patient supports.

Air inlet 20, in its various embodiments, provides a quick and easy way of coupling and de-coupling air supply hose 46 thereto. Such coupling does not require any twisting movement or complex alignment of parts. Further, air inlet 20 easily and reliably returns to its flat orientation when not in use. Its flat orientation enables air inlet 20 to occupy less space and to be more easily stowed. Because air inlet 20 is made from a flexible material, patient support 74 can be rolled, folded, or otherwise compacted into a small amount of space. Air inlet 20 also does not provide a physically hard structure that may provide discomfort to a patient located on patient support 74, even when patient support 74 is not inflated.

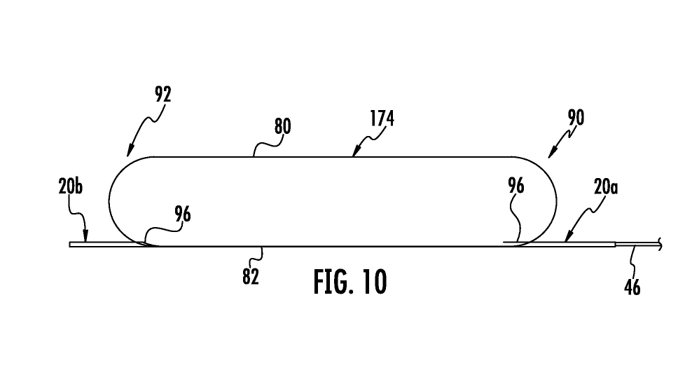

In at least some embodiments of the patient support, more than one air inlet 20 or 120 may be incorporated into the patient support. An example of an illustrative patient support 174 having multiple air inlets is shown in FIG. 10. Patient support 174 includes a first air inlet 20a attached to a first side 90 of support 174, and a second air inlet 20b attached to a second side 92 of support 174. Patient support 174 is depicted in FIG. 10 in a sectional view in order to illustrate one example of how the components of air inlets 20a and b that extend inside of support 174 may be constructed. For example, each air inlet 20 in the example of FIG. 10 includes an extension 96 that extends into the interior of patient support 174. Extensions 96 may be made of the same flexible material as the rest of air inlets 20 and/or 120, or they may be made of other material. Extensions 96 serve to create a check valve effect for the air inlet that is not currently receiving air from an air supply hose 46. For example, in the illustration of FIG. 10, air inlet 20b is not attached to an air hose 46 while air inlet 20a is. Extension 96 of air inlet 20b extends downwardly and effectively blocks off access to air inlet 20b from the interior of patient support 174. That is, air inside of patient support 174 is prevented by extension 96 from escaping through inlet 20b. The pressure of the air inside patient support 174 helps push extension 96 against the wall of support 174, thereby maintaining the air-tight blockage of air inlet 20b.

In contrast, the air inlet 20a that is currently being used is not affected by extension 96. That is, the air flowing through hose 46 has sufficient pressure to push extension 96 out of the way and allow air to enter into the interior of support 174. Once the blower or pump that is attached to hose 46 is shut off, the flow of air through hose 46 ceases, and the pressure exerted against extension 96 of air inlet 20a by the formerly inflowing air ceases. This allows extension 96 to drop against the wall of support 174—aided by the air pressure inside of support 174—thereby automatically sealing air inlet 20a against air leakage out of support 174. Air inlet 20 will therefore automatically self-seal when air ceases to flow through hose 46. It will, of course, be understood by those skilled in the art that the shape, construction, and overall configuration of extensions 96 may be varied substantially from that illustrated in FIG. 10.

Air inlet 20 may be manufactured from a flexible material, such as a suitable plastic or plastic-coated fabric that is generally air impermeable. This prevents air from escaping through the material of air inlet 20, while allowing air inlet 20 to be compressed into a flat orientation when not in use. Additional examples of the types of material out of which inlet 20 may be constructed may be found in the two patents referenced above and incorporated herein by reference.

The foregoing embodiments of the invention are exemplary and can be varied in many ways, and, further, features of one embodiment may be combined with features of another embodiment and used in combination with features of more than one embodiment. Such feature variations are not to be regarded as a departure from the spirit and scope of the invention, and all such modifications are intended to be including within the scope of the following claims.

What is claimed is:

1. An inflatable patient support device comprising:
a flexible body adapted to be inflated and deflated, said body including a top surface adapted to support a patient thereon; and
an air inlet coupled to said body, said air inlet including a plurality of resilient members positioned adjacent an opening defined in said air inlet, said resilient members adapted to bias said opening toward a flat orientation, said resilient members further adapted to flex away from each other toward a non-flat orientation when a compressive force is applied to said inlet substantially parallel to a longitudinal extent of said resilient members.

2. The device of claim 1 wherein said resilient members are leaf springs.

3. The device of claim 2 wherein said leaf springs are made from a thermoset urethane.

4. The device of claim 1 wherein said air inlet further includes a first tubular section adjacent said opening and a second tubular section adjacent said first tubular section, said second tubular section having an inside diameter less than an inside diameter of said first tubular section.

5. The device of claim 1 further including a plurality of magnets positioned adjacent said opening, said magnets arranged such that a magnetic force urges said resilient members toward said flat orientation.

6. The device of claim 5 wherein a first one of said plurality of magnets and a first one of said resilient members are positioned together as laminates.

7. The device of claim 1 wherein said resilient members comprise elongated leaf springs and a first one of said leaf springs is positioned substantially around a first half of said opening, and a second one of said leaf springs is positioned substantially around a second half of said opening.

8. The device of claim 7 wherein said leaf springs have longitudinal axes that are substantially parallel to each other when said inlet is in said flat orientation.

9. The device of claim 1 further including a plastic, releasable seal positioned adjacent said inlet, said releasable seal including a first half and a second half, said first half adapted to releasably engage said second half in an airtight manner when said inlet is in the flat orientation.

10. The device of claim 1 wherein said resilient members include an interior surface adapted to engage a collar on a hose inserted into said inlet when the compressive force applied to the inlet is terminated, said engagement of said interior surface with said collar preventing withdrawal of said hose out of said inlet.

11. The device of claim 1 wherein said flexible body further includes a bottom having a plurality of air passages defined therein, said air passages adapted to allow air from inside said body to escape to generate an air cushion underneath said flexible body to thereby facilitate movement of said body over a surface.

12. An air inlet for an inflatable patient transfer device having a flexible body adapted to be inflated and deflated, wherein said body includes a bottom surface and a top surface and said bottom surface has a plurality of air passages adapted to allow air from inside said body to escape to generate an air cushion underneath said flexible body and said top surface is adapted to support a patient thereon, said air inlet comprising:
a first substantially planar surface; and
a second substantially planar surface positioned opposite said first surface and having first and second sides, said first and second sides of said second surface coupled to first and second sides of said first surface, said first and second surfaces adapted to flex between a first position in which said first and second surfaces are substantially flat and parallel to each other and a second position in which said first and second surfaces form a curved shape sized to accept an air supply hose between said first and second surfaces.

13. The inlet of claim 12 further including a plurality of magnets, at least a first one of said magnets positioned along said first surface, and at least a second one of said magnets positioned along said second surface, said first and second magnets oriented such that a magnetic force between said first and second magnets urges said first and second surfaces toward said first position.

14. The inlet of claim 12 further including a plurality of resilient members, at least a first one of said resilient members positioned along said first surface, and at least a second one of said resilient members positioned along a second surface, said first and second resilient members adapted to flex toward the second position when a compressive force is applied to said first and second sides, said resilient members further adapted to flex back toward said first position when the compressive force is removed.

15. The inlet of claim 14 further including a plurality of magnets, at least a first one of said magnets positioned along said first surface, and at least a second one of said magnets positioned along said second surface, said first and second magnets oriented such that a magnetic force between said first and second magnets urges said first and second surfaces toward said first position.

16. The inlet of claim 15 wherein said first and second surfaces define a first tubular section when in said second position, and said inlet further includes a second tubular section adjacent said first tubular section, said second tubular section having an inside diameter less than an inside diameter of said first tubular section.

17. The inlet of claim 16 wherein said resilient members are leaf springs, and said first one of said plurality of magnets and said first one of said resilient members are positioned together as laminates.

18. The inlet of claim 17 further including a plastic, releasable seal, said releasable seal including a first half attached to said first surface and a second half attached to said second surface, said first half adapted to releasably engage said second half in an airtight manner when said inlet is in the first position.

19. A method of using an air inlet of an inflatable patient support device and an air supply hose, said method comprising:
applying a compressive force to opposite sides of the air inlet until the air inlet flexes from a substantially flat shape into a curved shape having an opening sized to receive the air supply hose;
inserting the air supply hose into the opening until a collar defined on the air supply hose moves past an edge defined in an interior of said inlet; and
terminating said compressive force to allow said edge to engage a portion of said collar and to thereby resist removal of the air supply hose from the air inlet.

20. The method of claim 19 wherein said applying a compressive force to opposite sides of the air inlet includes applying a force sufficient to overcome a magnetic attraction between magnets positioned to magnetically urge the air inlet toward the flat shape.

21. The method of claim 19 further including unlocking a plastic seal that hermetically seals said inlet prior to applying the compressive force to opposite sides of the air inlet.

22. The method of claim 19 further including:
pumping air through said air supply hose and into said air inlet;
applying another compressive force to opposite sides of the air inlet until the edge of the air inlet moves away from the collar of the air supply hose; and
removing said air supply hose from the air inlet.

23. The method of claim 22 wherein said inflatable patient transfer device includes a body having a top surface and a bottom surface, said bottom surface having a plurality of air passages adapted to allow air from inside said body to escape to generate an air cushion underneath said flexible body, said top surface adapted to support a patient thereon; wherein said method further includes moving said patient transfer device over the air cushion.
